(19) United States
(12) Patent Application Publication
(10) Pub. No.: US 2025/0098766 A1
(43) Pub. Date: Mar. 27, 2025

(54) Heating Assembly for an Aerosol Generating Device

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 18/729,940

(22) PCT Filed: Jan. 30, 2023
(86) PCT No.: PCT/EP2023/052171

§ 371 Date: Jul. 18, 2024

(30) Foreign Application Priority Data
Jan. 31, 2022 (EP) 22154350.7

(51) Int. Cl. A24F 40/46; A24F 40/70; H05B 3/42

(52) U.S. Cl. CPC A24F 40/46; A24F 40/70; H05B 3/42

(57) ABSTRACT

A heating assembly for an aerosol generating device includes an insulator having an inner wall and an outer wall, wherein the inner wall of the insulator defines a cavity having an opening configured to receive an aerosol generating substrate. The heating assembly further includes a heater located on an outer surface of the inner wall of the insulator, wherein the heater is configured to heat the aerosol generating substrate received within the cavity by thermal conduction to generate an aerosol. The heating assembly further includes a first electrical connector and a second electrical connector each extending through the outer wall of the insulator to the heater, wherein an electrical path is formed between the first electrical connector and the second electrical connector by way of the heater.

### FIELD OF THE INVENTION

The present invention relates to a heating assembly for an aerosol generating device, a method of manufacturing a heating assembly for an aerosol generating device, and an aerosol generating device comprising a heating assembly. The disclosure is particularly applicable to a portable aerosol generating device, which may be self-contained and low temperature. Such devices may heat, rather than burn, tobacco or other suitable aerosol substrate materials by conduction, convection, and/or radiation, to generate an aerosol for inhalation.

### BACKGROUND

The popularity and use of reduced-risk or modified-risk devices (also known as vaporisers) has grown rapidly in the past few years as an aid to assist habitual smokers wishing to quit using traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol substrate (i.e. consumable) that typically comprises moist leaf tobacco or other suitable aerosolisable material to a temperature typically in the range of 150° C. to 300° C. Heating an aerosol substrate, but not combusting or burning it, releases an aerosol that comprises the components sought by the user but not the undesirable by-products of combustion. In addition, the aerosol produced by heating the tobacco or other aerosolisable material does not typically comprise the burnt or bitter taste that may result from combustion that can be unpleasant for the user.

Within such aerosol generating devices, it is desirable to improve the efficiency of the heating operation such that the battery life of the device may be extended. To this end, vacuum insulators have been implemented within aerosol generating devices in order to thermally insulate the cavity in which an aerosol substrate is heated, thereby limiting thermal losses to the external environment.

However, heating assemblies including vacuum insulators are difficult to manufacture. An object of the present invention is to address this issue.

### SUMMARY OF THE INVENTION

According to a first aspect of the invention, there is provided a heating assembly for an aerosol generating device, comprising: an insulator having an inner wall and an outer wall, wherein the inner wall of the insulator defines a cavity having an opening configured to receive an aerosol generating substrate; a heater located on an outer surface of the inner wall of the insulator, wherein the heater is configured to heat the aerosol generating substrate received within the cavity by thermal conduction to generate an aerosol; and a first electrical connector and a second electrical connector each extending through the outer wall of the insulator to the heater, wherein an electrical path is formed between the first electrical connector and the second electrical connector by way of the heater.

In a preferred embodiment, the insulator is a vacuum insulator, and a vacuum is enclosed between the inner wall and the outer wall. In alternative embodiments insulating material may be disposed between the inner wall and the outer wall of the insulator. Examples of insulating material include powder, fibrous material such as aerogel, or air.

Also described herein is a heating assembly for an aerosol generating device, comprising: a vacuum insulator having an inner wall and an outer wall between which a vacuum is enclosed, wherein the inner wall of the vacuum insulator defines a cavity having an opening configured to receive an aerosol generating substrate; a heater located on an outer surface of the inner wall of the vacuum insulator, wherein the heater is configured to heat the aerosol generating substrate received within the cavity by thermal conduction to generate an aerosol; and a first electrical connector and a second electrical connector each extending through the outer wall of the vacuum insulator to the heater, wherein an electrical path is formed between the first electrical connector and the second electrical connector by way of the heater.

In this way, a passage for electricity to be supplied to the heater, which is confined within the vacuum, is provided through the outer wall of the vacuum insulator. This avoids having to route an electrical connector or extend the heater between the inner wall and outer wall of the vacuum insulator, thereby simplifying the manufacturing process and improving the durability of the heating assembly. In particular, as the outer wall of the vacuum insulator is formed such that the first electrical connector and the second electrical connector each extend through the outer wall, the heater that is isolated within the vacuum may be connected to an external power supply via the first electrical connector and the second electrical connector. Hence, the ease of manufacturing is improved as attachment of the outer wall (in combination with the through-extending first and second electrical connectors) to the inner wall (in combination with the heater) results in a fully functional heating assembly comprising an isolated heater. In contrast, for example, in heating assemblies in which the heater is connectable to an external power supply by way of a connector or extension of the heater extending between the inner wall and the outer wall, attachment of the inner wall to the outer wall may not isolate the heater and further sealing operations may be required to seal the gap between the inner wall and the outer wall through which the connector extends.

Furthermore, by providing the heater within the vacuum between the inner wall and the outer wall, rather than within the cavity, the compactness and thermal efficiency of the heating assembly is optimised. The heater is in thermal contact with the inner wall of the vacuum insulator and can heat the aerosol generating substrate via the inner wall. The vacuum inhibits heat from escaping from the cavity by conduction via the outer wall. The inner wall of the vacuum insulator can thus serve a dual purpose of transferring heat to an aerosol generating substrate received in the cavity while also maintaining an insulating vacuum to insulate the cavity. This creates an efficient and compact heating assembly for an aerosol generating device.

Preferably, the first electrical connector and the second electrical connector are resiliently biased towards the heater. More preferably, the first electrical connector and the second electrical connector are configured to apply a constant (e.g. normal) force against the heater, thereby counteracting any unwanted movement which might otherwise cause an intermittent connection. In this way, it is ensured that the first electrical connector and the second electrical connector remain in electrical contact with the heater. This is particularly important due to the portable nature of aerosol generating devices, which means that the heating assembly is likely to experience frequent mechanical shocks and vibrations.

Preferably, the first electrical connector and the second electrical connector comprise spring-loaded pins which are resiliently biased towards the heater. In this way, a reliable and durable form of electrical connector is provided. It will be appreciated by the skilled person that spring-loaded pins may also be referred to as pogo pins.

Preferably, the cavity defined by the inner wall of the vacuum insulator is tubular and extends from a base to the opening. For example, the inner wall defining the opening and the base may be substantially cylindrical, i.e. cup-shaped. The base may be described as a closed base. In this way, the cavity is configured to receive a rod of aerosol generating substrate such that a major portion of the rod of aerosol generating substrate, including an end portion of the rod, is entirely enclosed by the inner wall. Therefore, as the vacuum insulator completely surrounds the major portion of aerosol generating substrate, a more effective means of insulation is provided in contrast to, for example, a sleeve shaped inner wall which is open at both longitudinal ends. In other words, the inner wall of the present invention defines a blind bore, rather than a through-hole.

Advantageously, providing the heater on the inner wall around the full circumference of the cavity enables a more homogenous heating of the aerosol generating substrate, which may generate a better quality aerosol for the user to enjoy. This may also enable faster heating of the aerosol generating substrate to aerosol generating temperatures.

Preferably, the base is formed as a flat surface arranged perpendicular to the longitudinal axis of the insulator. In this way, the shape of the insulator including the base results in a stable and reliable connection being formed between the electrical connectors and the heater (e.g. the electrical contact pads located on the base) due to the normal reaction force acting against the electrical connectors. This particularly applies in a case that the first electrical connector and the second electrical connector are resiliently biased towards the heater, i.e. the first electrical connector and the second electrical connector are resiliently biased towards the flat surface of the base.

Preferably, the first electrical connector and the second electrical connector extend in directions that are parallel to the tubular cavity.

Preferably, the first electrical connector and the second electrical connector connect to the heater adjacent the base. In other words, the first electrical connector and the second electrical connector connect to the heater at the base of the inner wall. In this way, the heating portion of the heater may be provided around the circumference of the cavity, whereas the electrical connecting portion of the heater is located at the base which interfaces with an end portion of the rod aerosol generating substrate, which is a less desirable area for heating.

Preferably, the first electrical connector and the second electrical connector are in line with the cavity such that the first electrical connector and the second electrical connector connect to the heater coincident to the (closed) base of the inner wall. In this way, the first electrical connector and the second electrical connector are arranged perpendicular to the base of the inner wall.

Preferably, the heater comprises a heating track extending between a first electrical contact pad and a second electrical contact pad, and wherein the first electrical connector and the second electrical connector connect to the heater via the first electrical contact pad and the second electrical contact pad respectively.

Preferably, the heater is a resistive heater. In this way, a compact, simple and easy to power form of heater is provided. Alternatively, the heater could be an induction heater powered by a coil surrounding the vacuum insulator.

Preferably, the heater is printed or coated on the outer surface of the inner wall of the vacuum insulator. In this way, reliable thermal contact is provided between the heater and the inner wall. Moreover, the ease of manufacturing may be further improved.

Preferably, the outer wall of the vacuum insulator has one or more apertures through which the first electrical connector and the second electrical connector extend. In this way, the one or more apertures provide a passage for electricity to be supplied to the heater, which is confined with the vacuum. This avoids having to route an electrical connector between the inner wall and outer wall of the vacuum insulator, thereby simplifying the manufacturing process and improving the durability of the heating assembly.

In one example, the outer wall of the vacuum insulator may have a first aperture through which the first electrical connector extends and a second aperture through which the second electrical connector extends. In another example, the outer wall of the vacuum insulator may have an aperture through which the first electrical connector and the second electrical connector each extend.

Preferably, electrically insulating material is provided in the one or more apertures surrounding the first electrical connector and the second electrical connector. In this way, the electrically insulating material prevents any contact between the first and second electrical connectors and the outer wall of the vacuum insulator, thereby preventing electricity being conducted to the outer wall of the vacuum insulator.

Preferably, the outer wall of the vacuum insulator comprises a metal such as stainless steel and/or a plastic such as polyether ether ketone, PEEK.

According to a second aspect of the invention, there is provided an aerosol generating device comprising the heating assembly of the first aspect.

According to a third aspect of the invention, there is provided a method of manufacturing a heating assembly for an aerosol generating device, comprising: providing an outer wall having one or more apertures; arranging a first electrical connector and a second electrical connector such that the first electrical connector and the second electrical connector extend through the one or more apertures of the outer wall; providing an inner wall; providing a heater on an outer surface of the inner wall; coupling the inner wall to the outer wall to form an enclosed space between the outer wall and the inner wall in which the heater is located, wherein an electrical path is formed between the first electrical connector and the second electrical connector by way of the heater; and preferably forming a vacuum within the enclosed space between the outer wall and the inner wall.

### BRIEF DESCRIPTION OF DRAWINGS

Embodiments of the invention are now described, by way of example, with reference to the drawings, in which:

FIG. 1 is a perspective view of an aerosol generating device comprising a heating assembly according to an embodiment of the invention;

FIG. 2 is a perspective schematic view of the heating assembly according to an embodiment of the invention;

FIG. 3 is a cross-sectional schematic view of the heating assembly of FIG. 2; and

FIG. 4 is a flow diagram showing method steps for manufacturing the heating assembly according to an embodiment of the invention.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

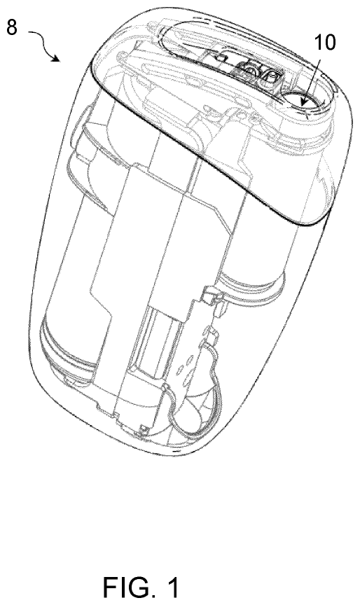

FIG. 1 illustrates an aerosol generating device 8 according to an embodiment of the invention. The aerosol generating device 8 is illustrated in an assembled configuration with exemplary internal components visible. The aerosol generating device 8 is a heat-not-burn device, which may also be referred to as a tobacco-vapour device, and comprises a heating assembly 10 configured to receive an aerosol substrate such as a rod of aerosol generating material, e.g. tobacco. The aerosol generating device 8 may comprise a power source such as a battery and control circuitry for controlling the supply of power from the power source to the heating assembly 10. The heating assembly 10 is operable to heat, but not burn, the rod of aerosol generating material to produce a vapour or aerosol for inhalation by a user. Of course, the skilled person will appreciate that the aerosol generating device 8 depicted in FIG. 1 is simply an exemplary aerosol generating device according to the invention. Other types and configurations of tobacco-vapour products, vaporisers, or electronic cigarettes may also be used as the aerosol generating device according to the invention.

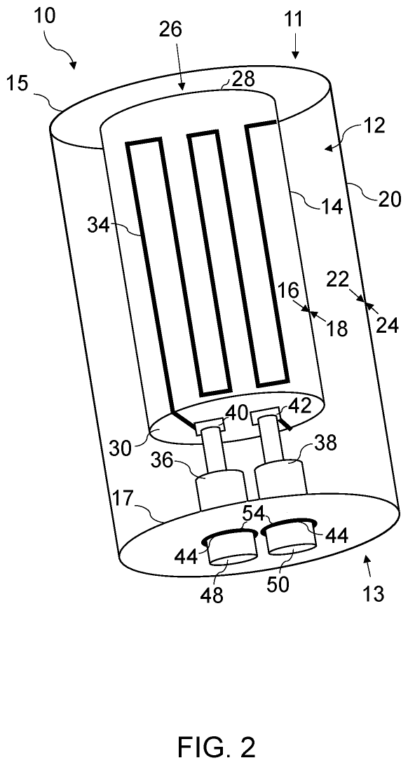

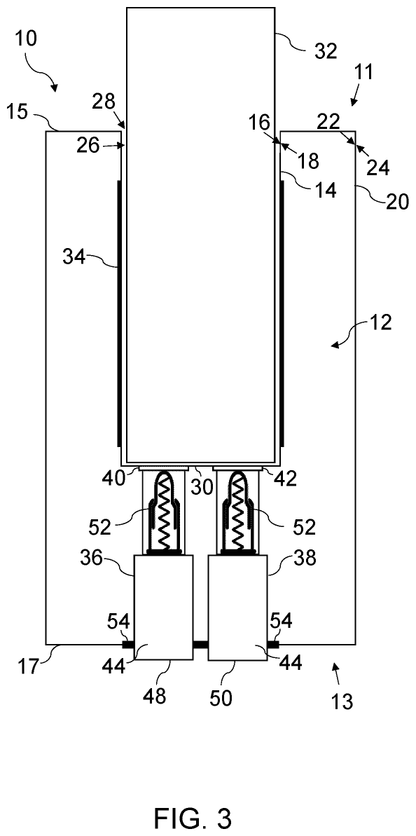

FIG. 2 shows a perspective view of the heating assembly 10 according to an embodiment of the invention. Similarly, FIG. 3 shows a cross-sectional schematic view of the heating assembly 10.

The heating assembly 10 comprises a vacuum insulator 12 having an inner wall 14 and an outer wall 20 between which a vacuum is enclosed. The vacuum insulator 12 extends from a first end 11 to a second end 13, i.e. the vacuum insulator 12 is elongate and defines a longitudinal axis. The vacuum insulator 12 defines a cavity 26 in which an aerosol generating substrate 32 may be received. Specifically, a top portion 15 of the vacuum insulator 12 at the first end 11 has an opening 28 through which the aerosol generating substrate 26 may be inserted into the cavity 26. The vacuum insulator 12 may therefore be referred to as cup-shaped.

The vacuum insulator 12 has an approximately elliptical or circular cross-section when viewed along one of its ends 11, 13, parallel to its longitudinal axis. In particular, in the depicted embodiment, the vacuum insulator 12 is substantially cylindrical. However, in alternative embodiments, the vacuum insulator 12 may be formed in other types of cross-sectional shape, for example shapes that are approximately square or polygonal.

The inner wall 14 of the vacuum insulator 12 is tubular, e.g. substantially cylindrical, and has an outer (e.g. circumferential) surface 18 and an inner (e.g. circumferential) surface 16. The inner wall 14 further comprises a base 30. The outer wall 20 is tubular, e.g. substantially cylindrical, and has an outer (e.g. circumferential) surface 24 and an inner (e.g. circumferential) surface 22. The outer wall 20 comprises a base portion 17 at the second end 13 of the vacuum insulator 13.

The inner wall 14 and the outer wall 20 are spaced radially apart from one another to define an enclosed space between them in which a vacuum is formed. Specifically, in the illustrated embodiment, the inner wall 14 and outer wall 20 are formed as concentric cylinders which are coupled at the first end 11 of the vacuum insulator 12. In a first example, the top portion 15 of the vacuum insulator 12 may be an integral part of the outer wall 20, which is attached to the inner wall 14 at the first end 11. In a second example, the top portion 15 of the vacuum insulator 12 may be an integral part of the inner wall 14, which is attached to the outer wall 20 at the first end 11. In a third example, the top portion 15 of the vacuum insulator 12 may be an additional component that couples the inner wall 14 and the outer wall 20 at the first end 11.

The skilled person will understand that the term “vacuum” refers to a space in which the pressure is considerably lower than atmospheric pressure due to the removal of free matter, in particular air. The quality of the vacuum formed between the inner wall 14 and the outer wall 20 may be a low vacuum, a medium vacuum, or a high vacuum.

In alternative embodiments, the vacuum insulator 12 may more generally be referred to as an insulator 12. That is, the insulator 12 is not limited to being a vacuum insulator. For example, instead of a vacuum, insulating material may be disposed between the inner wall 14 and outer wall 20 of the insulator 12. Examples of insulating material include powder, fibrous material such as aerogel, and/or air.

The inner wall 14 of the vacuum insulator 12 defines the cavity 26 in which the aerosol generating substrate 32 may be received. In particular, the cavity defined by the inner wall 14 of the vacuum insulator 12 is tubular (e.g. cylindrical) and extends from the base 30 to the opening 26. In this way, an aerosol generating substrate 32 in the form of an elongate rod (e.g. cylinder) may be inserted into the cavity 26 via the opening 28, such that the aerosol generating substrate 32 interfaces with the inner surface 16 and the base 30 of the inner wall 14. In this way, other than a portion of the aerosol generating substrate 32, which protrudes from the opening 28 to be received in the mouth of a user, the vacuum insulator 12 entirely surrounds the aerosol generating substrate 32 which therefore maximises the effectiveness of the insulation.

Typically, the aerosol generating substrate 32 is a disposable and replaceable article (also known as a “consumable”) which may, for example, contain tobacco as the aerosol generating substrate 32.

The heating assembly 10 further comprises a heater 34 disposed on the outer surface 18 of the inner wall 14 of the vacuum insulator 12. That is, the heater 34 is located between the inner wall 14 and outer wall 20 of the vacuum insulator 12 within the vacuum. The heater 34 is configured to heat the inner wall 14 of the vacuum insulator 12 by conduction so that the inner wall 14 heats the aerosol generating substrate 32 and the air inside the cavity 26 by conduction and radiation. The heater 34 can be powered by a battery or any other power source provided on an aerosol generating device, as will be discussed further below.

The heater 34 is a resistive heating element that generates heat by resistive heating (also referred to as Joule heating). The heater 34 comprises a heating track (e.g. a sinuous heating pattern) that at least partially surrounds the cavity 26 on the outer surface 18 of the inner wall 14 of the vacuum insulator 12. Specifically, the heating track is wrapped around the inner wall 14 of the vacuum insulator 12 in a circumferential direction, and preferably around the entire circumference of the cavity 26. Advantageously, surrounding the cavity 26 around substantially its full circumference results in the aerosol generating substrate 32 being heated faster or more homogeneously. Of course, the skilled person will appreciate that the particular shape and arrangement of the heater 34 may vary. For example, the heater 34 may comprise a heating sheet which partially or entirely surrounds the outer surface 18 of the inner wall 14 of the vacuum insulator 12.

The heater 34 may be printed, coated or otherwise attached onto the outer surface 18 of the inner wall 14 of the vacuum insulator 12. Thus, the heater 34 may provide “trace heating” to the cavity 26.

The heater 34 may comprise metal (e.g. Nichrome, Kanthal, or Cupronickel), ceramic or any other suitable resistive heating material. As will be appreciated by the skilled person, the heater 34 is not limited to a resistive heating element, and the type of heater 34 may vary. For example, the heater 34 may be an induction heater powered by a coil surrounding the vacuum insulator 12.

The heater 34 further comprises a first electrical contact pad 40 and a second electrical contact pad 42 located on the base 30 of the inner wall 14 within the vacuum. The heating track of the heater 34 connects the first electrical contact pad 40 to the second electrical contact pad 42.

The heating assembly 10 further comprises a first electrical connector 36 and a second electrical connector 38 that each extend from the heater 34, across the vacuum, and exit the vacuum insulator 12 through the outer wall 20 of the vacuum insulator 12. Specifically, the outer wall 20 of the vacuum insulator 12 comprises a first aperture 44 and a second aperture 44 through which the first electrical connector 36 and the second electrical connector 38 respectively extend. The skilled person will appreciate that in alternative embodiments, the outer wall 20 of the vacuum insulator 12 may only comprise a single aperture, through which both the first electrical connector 36 and the second electrical connector 38 extend.

The apertures 44 are located in the base portion 17 of the outer wall 20, such that the first electrical connector 36 and the second electrical connector 38 extend through the base portion 17. However, the first electrical connector 36 and the second electrical connector 38 are not limited to extending through the base portion 17 of the outer wall 20, and the position of the apertures 44 within the outer wall 20 may vary. For example, one or more of the apertures 44 may be provided in the circumferential portion of the outer wall 20.

The first electrical connector 36 and the second electrical connector 38 each connect to the heater 34 adjacent the inner wall 14 of the vacuum insulator 12. In this way, an electrical path is formed between the first electrical connector 36 and the second electrical connector 38 via the heater 34. In particular, the first electrical connector 36 and the second electrical connector 38 connect to the first electrical contact pad 40 and the second electrical contact pad 42 of the heater 34 adjacent the base 30, but the skilled person will appreciate that the location of connection to the heater 34 with respect to the cavity 26 may vary.

The first electrical contact 40 and the second electrical contact pad 42 are depicted as square electrical contact pads, but in alternative embodiments the first electrical connector 36 and the second electrical connector 38 may connect to the heater 34 by other forms and arrangement of electrical contact.

The first electrical connector 36 and the second electrical connector 38 comprise a first electrical terminal 48 and a second electrical terminal 50 respectively, which are at least partially located outside the vacuum insulator 12. The first electrical connector 36 and the second electrical connector 38 are connectable to an external circuit via the first electrical terminal 48 and the second electrical terminal 50. That is, the first electrical terminal 48 and the second electrical terminal 50 are configured to be connected to complementary external electrical terminals.

In particular, the first electrical terminal 48 and the second electrical terminal 50 may be connectable to an aerosol generating device 8 including control circuitry and a power source such as a battery. In this way, an electrical circuit may be formed between the power source and the heater 34 via the first electrical connector 36 and the second electrical connector 38. In use, the heater 34 is supplied with electrical power through the outer wall 20 of the vacuum insulator 12 from the power source of the aerosol generating device 8, thereby generating heat by Joule heating. The heat is transferred to the aerosol generating substrate 32 received within the cavity 26 via the inner wall 14 to generate an aerosol for inhalation by the user.

An electrically insulating material 54, such as polyether ether ketone (PEEK), is provided within the first aperture 44 and the second aperture 44. The electrically insulating material 54 surrounds the first electrical connector 36 and the second electrical connector 38 to prevent any contact between the first electrical connector 36 and the second electrical connector 38 and the outer wall 20 of the vacuum insulator 12. In this way, the electrically insulating material 54 prevents electricity being conducted to the outer wall 20 of the vacuum insulator 12 via the first electrical connector 36 and the second electrical connector 38.

As illustrated in FIG. 3, the first electrical connector 36 and the second electrical connector 38 each comprise a spring-loaded pin 52, which is also known as a pogo pin. Each spring-loaded pin 52 is arranged adjacent to the heater 34 such that the first electrical connector 36 and the second electrical connector 38 form an electrical contact with the heater 34 via the spring-loaded pins 52. Each spring-loaded pin 52 applies a constant normal force against the heater 34, and in particular against the first electrical contact 40 and the second electrical contact pad 42, by virtue of an integrated spring, thereby counteracting any unwanted movement which might otherwise cause an intermittent connection.

Of course, the skilled person will understand that the first electrical connector 36 and the second electrical connector 38 are not limited to comprising spring-loaded pins 52, and other forms of electrical connector mechanisms may be used. For example, the first electrical connector 36 and the second electrical connector 38 may each comprise other types of electrical connector mechanisms which are configured to maintain electrical contact with the heater 34, for example any form of electrical connector which may be resiliently biased towards the heater 34.

In the illustrated embodiment, the first electrical connector 36 and the second electrical connector 38 are a pair of adjacent connectors which are arranged parallel to one another. More particularly, the first electrical connector 36 and the second electrical connector 38 are arranged parallel to the longitudinal direction of the heating assembly 10, i.e. parallel to the tubular cavity 26, and connect to the heater 34 adjacent to the base 30 of the inner wall 14. In this way, an efficient arrangement of components is provided resulting in a compact and durable heating assembly 10. However, in alternative embodiments, the first electrical connector 36 and the second electrical connector 38 may connect to the heater 34 at alternative locations with respect to the inner wall 14, for example adjacent to the (e.g. circumferential) outer surface 18 of the inner wall 14. The first electrical connector 36 and the second electrical connector 38 are also not limited to being arranged parallel to one another and/or the tubular cavity 26.

The inner wall 14 of the vacuum insulator 12 may comprise any appropriate material having properties suitable for transmitting heat from the heater 34 into the cavity 26, such as stainless steel or other metals, metal alloys, or ceramics.

Examples of suitable materials for the outer wall 20 include stainless steel and/or a plastic such as polyether ether ketone (PEEK). The skilled person will appreciate that, in the case of the outer wall 20 being made from an electrically insulating material such as PEEK, it may not be necessary to provide further electrically insulating material 54 within the apertures 44.

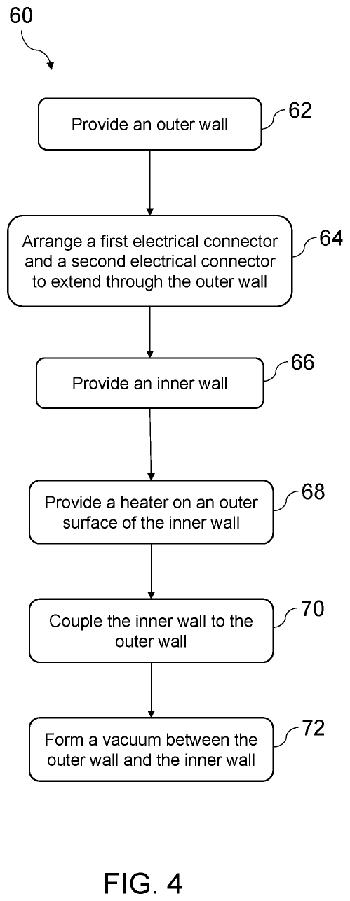

FIG. 4 illustrates a flow chart which is a method 60 of manufacturing a heating assembly according to an embodiment of the invention.

The method 60 begins at step 62, wherein an outer wall 20 is provided. Specifically, an outer wall 20 is provided having one or more apertures 44.

At step 64, a first electrical connector 36 and a second electrical connector 38 are arranged to extend through the outer wall 20. The first electrical connector 36 and the second electrical connector 38 pass through the one or more apertures 44 such that the first electrical connector 36 and the second electrical connector each provide an electrical path through the outer wall 20. Preferably, electrically insulating material 54 is arranged within the one or more apertures 44 to surround the first electrical connector 36 and the second electrical connector 38. The electrically insulating material 54 prevents any contact between the first electrical connector 36 and the second electrical connector 38 and the outer wall 20. The electrically insulating material 54 may also act to fix the first electrical connector 36 and the second electrical connector 38 in position with respect to the outer wall 20.

At step 66, an inner wall 14 is provided. At step 68, a heater 34 is provided on an outer surface 18 of the inner wall 14. For example, the heater 34 may be printed, coated or otherwise fixed to the outer surface 18 of the inner wall 14.

At step 70, the inner wall 14 is coupled to the outer wall 20 to form an enclosed space between the outer wall 20 and the inner wall 14 in which the heater 34 is located. The heater 34 is arranged to form an electrical connection with each of the first electrical connector 36 and the second electrical connector 38 such that an electrical path is formed between the first electrical connector 36 and the second electrical connector 38 via the heater 34.

Finally, at step 72, a vacuum is formed within the enclosed space between the outer wall 20 and the inner wall 14.

The skilled person will appreciate the shape, properties and configuration of the features discussed with reference to FIGS. 2 and 3 apply equally to the features discussed with reference to method 60.

1. A heating assembly for an aerosol generating device, comprising:
an insulator having an inner wall and an outer wall, wherein the inner wall of the insulator defines a cavity having an opening configured to receive an aerosol generating substrate;
a heater located on an outer surface of the inner wall of the insulator, wherein the heater is configured to heat the aerosol generating substrate received within the cavity by thermal conduction to generate an aerosol; and
a first electrical connector and a second electrical connector each extending through the outer wall of the insulator to the heater, wherein an electrical path is formed between the first electrical connector and the second electrical connector by way of the heater.

2. The heating assembly of claim 1, wherein the insulator is a vacuum insulator, and wherein a vacuum is enclosed between the inner wall and the outer wall.

3. The heating assembly of claim 1, wherein the first electrical connector and the second electrical connector are resiliently biased towards the heater.

4. The heating assembly of claim 3, wherein the first electrical connector and the second electrical connector comprise spring-loaded pins which are resiliently biased towards the heater.

5. The heating assembly of claim 1, wherein the cavity defined by the inner wall of the insulator is tubular and extends from a base of the inner wall to the opening such that an end portion of the received aerosol generating substrate is entirely enclosed by the inner wall.

6. The heating assembly of claim 5, wherein the base is formed as a flat surface arranged perpendicular to the length of the cavity,

7. The heating assembly of claim 5, wherein the first electrical connector and the second electrical connector extend in directions that are parallel to the tubular cavity.

8. The heating assembly of claim 7, wherein the first and second electrical connectors are arranged in line with the tubular cavity.

9. The heating assembly of claim 5, wherein the first electrical connector and the second electrical connector connect to the heater coincident to the base.

10. The heating assembly of claim 1, wherein the heater comprises a heating track extending between a first electrical contact pad and a second electrical contact pad, and wherein the first electrical connector and the second electrical connector connect to the heater via the first electrical contact pad and the second electrical contact pad respectively.

11. The heating assembly of claim 5,
wherein the heater comprises a heating track extending between a first electrical contact pad and a second electrical contact pad, and wherein the first electrical connector and the second electrical connector connect to the heater via the first electrical contact pad and the second electrical contact pad respectively, and
wherein the first electrical contact pad and the second electrical contact pad are located on the base of the inner wall.

12. The heating apparatus of claim 1, wherein the heater is a resistive heater.

13. The heating apparatus of claim 1, wherein the heater is printed or coated on the outer surface of the inner wall of the insulator.

14. The heating assembly of claim 1, wherein the outer wall of the insulator has one or more apertures through which the first electrical connector and the second electrical connector extend.

15. The heating assembly of claim 14, wherein electrically insulating material is provided in the one or more apertures surrounding the first electrical connector and the second electrical connector.

16. An aerosol generating device comprising the heating assembly of claim 1.

17. The aerosol generating device of claim 16, wherein the insulator is secured in the aerosol generating device by a fixing member configured to restrict longitudinal movement of the insulator.

18. A method of manufacturing a heating assembly for an aerosol generating device, comprising:
providing an outer wall having one or more apertures;
arranging a first electrical connector and a second electrical connector such that the first electrical connector and the second electrical connector extend through the one or more apertures of the outer wall;
providing an inner wall;
providing a heater on an outer surface of the inner wall; and
coupling the inner wall to the outer wall to form an enclosed space between the outer wall and the inner wall in which the heater is located, wherein an electrical path is formed between the first electrical connector and the second electrical connector by way of the heater.

19. The method of claim 18, further comprising forming a vacuum within the enclosed space between the outer wall and the inner wall.
